(19) United States
(12) Patent Application Publication
(10) Pub. No.: US 2009/0303415 A1
(43) Pub. Date: Dec. 10, 2009

(54) Backlight module with reflective diffuser and liquid crystal display with same

(75) Inventors: Yu-Ju Hsu, Miao-Li (TW); Ko-Wei Chien, Miao-Li (TW); Jia-Shyong Cheng, Miao-Li (TW)

Correspondence Address: WEI TE CHUNG;FOXCONN INTERNATIONAL, INC., 1650 MEMOREX DRIVE, SANTA CLARA, CA, 95050, US

(73) Assignee: INNOLUX DISPLAY CORP.

(21) Appl. No.: 12/455,826

(22) Filed: Jun. 8, 2009

(30) Foreign Application Priority Data
Jun. 6, 2008 (TW) 97121212

(51) Int. Cl. G02F 1/13357; G09F 13/04

(52) U.S. Cl. 349/64; 362/97.1

(57) ABSTRACT

An exemplary backlight module includes a first light source, and a diffusing film. The diffusing film includes a light incident surface adjacent to the first light source, a light emitting surface located at an opposite side thereof, and a plurality of first reflective portions provided at the light incident surface. A pitch between every two adjacent first reflective portions progressively increases with increasing distance away from the first light source. A liquid crystal display employing the backlight module is also provided.

### BACKGROUND

1. Technical Field

The present disclosure relates to a backlight module that includes a reflective diffuser, and a liquid crystal display (LCD) employing the backlight module.

2. Description of Related Art

Liquid crystal displays are commonly used as display devices for compact electronic apparatuses, not only because they provide good quality images but also because they are very thin. The liquid crystal in a liquid crystal display does not emit any light itself. The liquid crystal has to be lit by a light source to clearly and sharply display text and images. Thus, a backlight module is generally needed to uniformly illuminate the liquid crystal of the liquid crystal display. However, a brightness of the backlight module adjacent to a light source thereof is generally greater than that away from the light source.

What is needed, therefore, is a backlight module that can overcome the described limitation. What is also needed is a liquid crystal display employing the backlight module.

### BRIEF DESCRIPTION OF THE DRAWINGS

The components in the drawings are not necessarily drawn to scale, the emphasis instead being placed upon clearly illustrating the principles of at least one embodiment of the present disclosure. In the drawings, like reference numerals designate corresponding parts throughout various views, and all the views are schematic.

FIG. 1 is an exploded, isometric view of a liquid crystal display according to a first exemplary embodiment of the present disclosure, the liquid crystal display including a backlight module that includes a lower diffusing film.

FIG. 2 is a side, cross, assembly view of the backlight module of FIG. 1.

FIG. 3 is an inverted, isometric view of the lower diffusing film of FIG. 1, the lower diffusing film including a plurality of reflective strips.

FIG. 4 is a graph showing a distance-pitch relationship of the reflective strips and a distance from a center of the lower diffusing film.

FIG. 5 is similar to FIG. 3, but showing a corresponding view in the case of a lower diffusing film of liquid crystal display according to a second embodiment of the present disclosure.

FIG. 6 shows a bottom, plan view of a lower diffusing film and a light source of a liquid crystal display according to a third embodiment of the present disclosure.

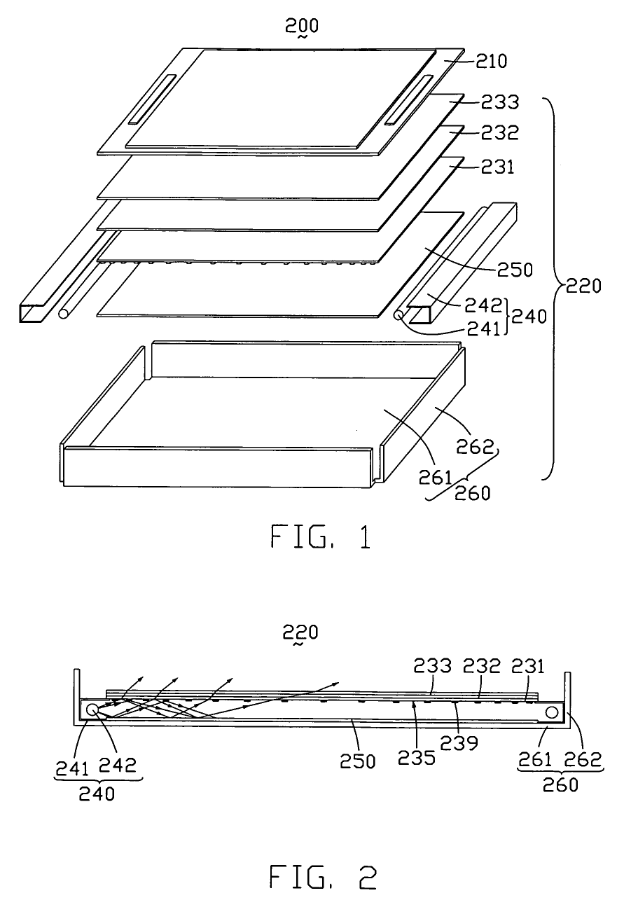

### DETAILED DESCRIPTION

Reference will now be made to the drawings to describe various embodiments in detail.

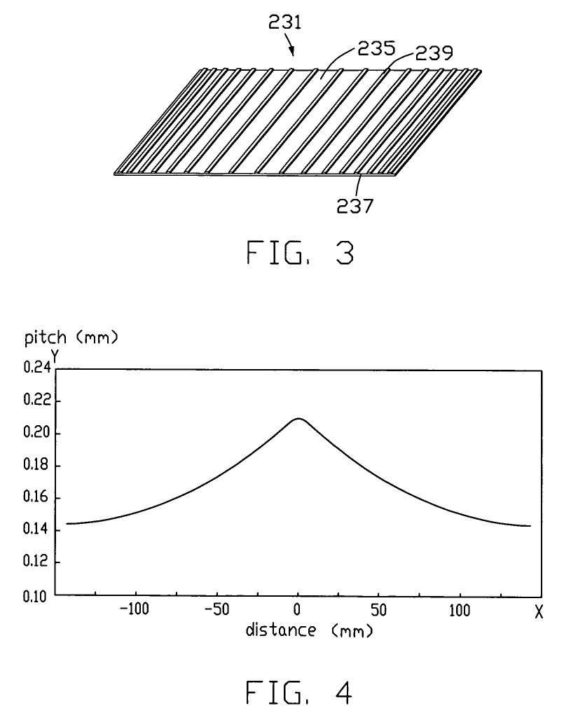

Referring to FIG. 3, a liquid crystal display 200 according to a first embodiment of the present disclosure is shown. The liquid crystal display 200 includes a liquid crystal panel 210, and a backlight module 220 capable of illuminating the liquid crystal panel 210. The backlight module 220 includes an upper diffusing film 233, a brightness enhancement film (BEF) 232, a lower diffusing film 231, a reflective film 250, a pair of light sources 240, and a bottom tray 260. The upper diffusing film 233, the BEF 232, the lower diffusing film 231, and the reflective film 250 are arranged in that order from top to bottom. The liquid crystal panel 210 is located above the upper diff-using film 233.

The bottom tray 260 includes a bottom wall 261, and four side walls 262 perpendicularly extend from four edges of the bottom wall 261, respectively. Thereby, the bottom wall 261 and the side walls 262 cooperatively define a space (not labeled) capable of receiving the upper diffusing film 233, the BEF 232, the lower diffusing film 231, the reflective film 250, and the light sources 240. In the illustrated embodiment, the side walls 262 are separate from each other. That is, a gap (not labeled) is defined where each two adjacent side walls 262 meet each other at a respective one of four corners (not labeled) of the bottom tray 260. The bottom tray 260 can for example be made from steel, iron, aluminum, magnesium, or any suitable alloy that includes at least one of these metals.

Referring also to FIG. 6, each light source 240 includes an illuminator 241 and a reflector 242. In the illustrated embodiment, the illuminator 241 is essentially linear and cylindrical, and can be a cold cathode fluorescent lamp (CCFL). The reflector 242 has an essentially U-shaped profile, and defines a rectangular opening (not labeled) for allowing light beams emitted from the illuminator 241 to exit therethrough. Bottom sides of the reflectors 242 are supported by the bottom wall 261 of the bottom tray 260.

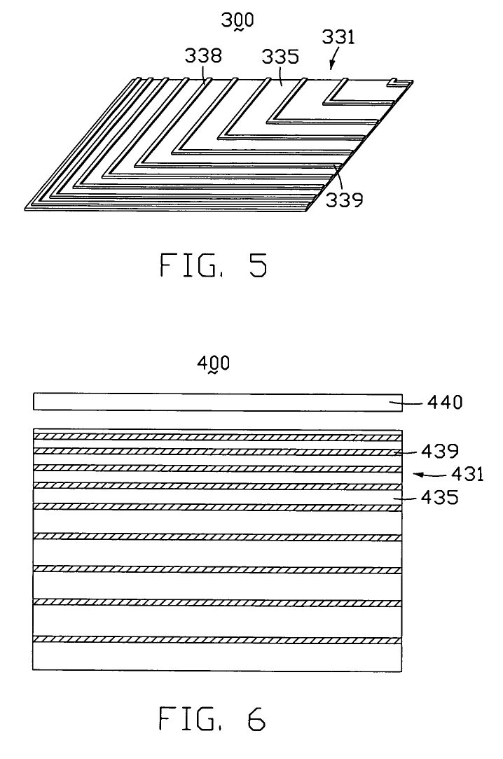

Referring also to FIG. 4, the lower diffusing film 231 includes a light incident surface 235, and a light emitting surface 237 at an opposite side of the light incident surface 235. The light incident surface 235 includes two opposite edges fittingly supported by top sides of the reflector 242. Therefore, the lower diffusing film 231 is spaced from the reflective film 250 by the reflectors 242, thus defining a space therebetween. The lower diffusing film 231 further includes a plurality of reflective strips 239 provided at the light incident surface 235. The reflective strips 239 are substantially linear, and are substantially parallel to an orientation of the linear illuminators 241. FIG. 5 is a graph showing a distance-pitch relationship. X represents a distance of the reflective strips 239 away from a center of the light incident surface 235. Y represents a pitch between every two adjacent reflective strips 239. It can be seen that the pitch between every two adjacent reflective strips 239 progressively decreases with increasing distance away from the center of the light incident surface 235. In the illustrated embodiment, the reflective strips 239 include a plurality of single-layered metal films having reflection ratio greater than 98%.

With the above-described configurations, light beams from the light sources 240 either reach the lower diffusing film 231 directly, or reach the lower diffusing film 231 after being reflected by the reflective film 250. The light beams reaching portions of the light incident surface 235 that are exposed to the reflective strips 239 are diffused and emit from the light emitting surface 237 of the lower diffusing film 231. The light beams reaching the reflective strips 239 are reflected toward the reflective film until they emit the lower diffusing film 231 after being reflected one or more times by the reflective film 250 and the reflective strips 239.

Although the brightness of the light beams adjacent to the light sources is greater than that adjacent to the center of the light incident surface 235, the pitches between every two adjacent reflective strips 239 progressively decrease with increasing distance away from the center of the light incident surface 235. Therefore, the brightness of the light beams passing through the lower diffusing film 231 is uniform. Thus, the liquid crystal panel 210 can be uniformly illuminated by the backlight module 220.

Referring to FIG. 7, a liquid crystal display 300 according to a second embodiment of the present disclosure is similar to the liquid crystal display 200. The liquid crystal display 300 includes a first illuminator (not shown), a second illuminator (not shown) orientated perpendicularly to the first illuminator, and a lower diffusing film 331. The lower diffusing film 331 includes a plurality of reflective strips (not labeled) provided at a light incident surface 335 thereof. The reflective strips are substantially L-shaped, and each includes a first reflective portion 338 parallel to the first illuminator, and a second reflective portion 339 parallel to the second illuminator. A pitch between every two adjacent first reflective portions 338 progressively increases with increasing distance away from the first illuminator, and a pitch between every two adjacent second reflective portions 339 progressively increases with increasing distance away from the second illuminator. The liquid crystal display 300 has advantages similar to those described above in relation to the liquid crystal display 200.

Referring to FIG. 8, a liquid crystal display 400 according to a third embodiment of the present disclosure is similar to the liquid crystal display 200. The liquid crystal display 400 includes a lower diffusing film 431, and a single linear light source 440 located adjacent to a side edge of the lower diffusing film 431. The lower diffusing film 431 includes a plurality of linear reflective strips 439 provided at a light incident surface 435 thereof. The linear reflective strips 439 are substantially linear, and are parallel to the light source 440. A pitch between every two adjacent reflective strips 439 progressively increases with increasing distance away from the light source 440. The liquid crystal display 400 has advantages similar to those described above in relation to the liquid crystal display 200.

It is to be understood, however, that even though numerous characteristics and advantages of preferred and exemplary embodiments have been set out in the foregoing description, together with details of the structures and functions of the embodiments, the disclosure is illustrative only; and that changes may be made in detail, especially in matters of shape, size, and arrangement of parts within the principles of the present disclosure to the full extent indicated by the broad general meaning of the terms in which the appended claims are expressed.

What is claimed is:

1. A backlight module comprising:
a first light source; and
a diffusing film comprising:
a light incident surface adjacent to the first light source;
a light emitting surface located at an opposite side thereof; and
a plurality of first reflective portions provided at the light incident surface, a pitch between every two adjacent first reflective portions increasing with increasing distance away from the first light source.

2. The backlight module of claim 1, further comprising a second light source, wherein the first and second light sources are located at two opposite sides of the light incident surface of the diffusing film.

3. The backlight module of claim 2, further comprising a plurality of second reflective portions provided at the light incident surface, wherein a pitch between every two adjacent second reflective portions increases with increasing distance away from the second light source.

4. The backlight module of claim 3, wherein the first and second reflective portions are substantially parallel to each other.

5. The backlight module of claim 1, wherein the first reflective portions are separate from each other, and are substantially parallel to the first light source.

6. The backlight module of claim 3, wherein the second reflective portions are separate from each other, and are substantially parallel to the second light source.

7. The backlight module of claim 1, further comprising a second light source, wherein the first and second light sources are located at two adjacent sides of the light incident surface of the diffusing film.

8. The backlight module of claim 7, further comprising a plurality of second reflective portions provided at the light incident surface, wherein a pitch between every two adjacent second reflective portions increases with increasing distance away from the second light source.

9. The backlight module of claim 8, wherein the first reflective portions are substantially parallel to the first light source, and the second reflective portions are substantially parallel to the second light source.

10. A backlight module comprising:
a first light source; and
a diffusing film comprising:
a first surface adjacent to the first light source;
a second surface located at an opposite side thereof; and
a plurality of first reflective portions provided at the first surface, a pitch between every two adjacent first reflective portions increasing with increasing distance away from the first light source.

11. The backlight module of claim 10, further comprising a second light source, wherein the first and second light sources are located at two opposite sides of the first surface of the diffusing film.

12. The backlight module of claim 11, further comprising a plurality of second reflective portions provided at the first surface, wherein a pitch between every two adjacent second reflective portions increases with increasing distance away from the second light source.

13. The backlight module of claim 12, wherein the first and second reflective portions are substantially parallel to each other.

14. The backlight module of claim 10, wherein the first reflective portions are separate from each other, and are substantially parallel to the first light source.

15. The backlight module of claim 12, wherein the second reflective portions are separate from each other, and are substantially parallel to the second light source.

16. The backlight module of claim 10, further comprising a second light source, wherein the first and second light sources are located at two adjacent sides of the first surface of the diffusing film.

17. The backlight module of claim 16, further comprising a plurality of second reflective portions provided at the first surface, wherein a pitch between every two adjacent second reflective portions increases with increasing distance away from the second light source.

18. The backlight module of claim 17, wherein the first reflective portions are substantially parallel to the first light source, and the second reflective portions are substantially parallel to the second light source.

19. The backlight module of claim 10, further comprising a reflective film located opposite to the first surface of the diff-using film.

20. A liquid crystal display comprising:
a liquid crystal panel; and
a backlight module capable of illuminating the liquid crystal panel, the backlight module comprising:
a light source; and
a diffusing film comprising:
a light incident surface adjacent to the light source;
a light emitting surface located at an opposite side thereof; and
a plurality of reflective portions provided at the light incident surface, a pitch between every two adjacent reflective portions progressively increasing with increasing distance away from the corresponding light source.
